(19) United States
(12) Patent Application Publication
(10) Pub. No.: US 2010/0182150 A1
(43) Pub. Date: Jul. 22, 2010

(54) RFID TAGS SYSTEM FOR PALLETS

(75) Inventor: Zvika Edelstain, Ra'anana (IL)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(73) Assignees: Carmel Container Systems Ltd., Caesarea Industrial Park (IL); Galbital RFID Solutions Ltd., Tel-Mond (IL)

(21) Appl. No.: 12/312,091

(22) PCT Filed: Oct. 16, 2007
(86) PCT No.: PCT/IL2007/001236

§ 371 Date: Mar. 5, 2010

Related U.S. Application Data
(60) Provisional application No. 60/851,764, filed on Oct. 16, 2006.

(51) Int. Cl. G08B 13/14; B23P 11/00

(52) U.S. Cl. 340/572.8; 29/428

(57) ABSTRACT

An RFID device (100) including a passive smart tag (120) embedded into a pallet (190) for the life of the pallet with no need of any special maintenance. The smart tag is integrated in a special supporting cube (110), sealed to protect the smart tag from any fluid penetration. The smart tag is implanted substantially vertically into the cube, forming an angle of 45—relative to each of the cube vertical sides, such that the smart tag can be read in a high level reliability and long at ranges, for example by a forklift—(50) approaching the pallet from any of the 4 possible directions.

### FIELD OF THE INVENTION

The present invention relates to radio frequency identification (RFID) system for use in tracking and detecting packages and other articles in specified areas, such as, but not limited to, warehouses. More specifically, the present invention relates to tracking and detecting packages and other articles, placed on pallets, which contain the built-in RFID tag system.

### BACKGROUND OF THE INVENTION AND PRIOR ART

The use of a radio frequency identification (RFID) system to identify and monitor objects is well known in the art. In such a system RFID labels or tags are attached or otherwise coupled to objects to be tracked or otherwise monitored. RFID technology refers to passive or active miniature antennae-containing tags requiring no internal power, known as “smart tags” that can be embedded in or attached to a product or material to convey information that can be electronically read.

Reference is made to FIG. 1 (prior art) showing a conventional RFID system consisting a reader 30 and a tag 20. The tag generates an electromagnetic response to an electronic signal from reader 30, transmitted by an antenna 32. Antenna 32 transmits an RE signal 35 which activates passive tag 20 thereby tag 20 transmits back to reader 30 a modulated signal 25, which contains the information stored in tag 20.

An RFID system may utilize a gated antenna array that includes a pair of vertically mounted antennas. The vertically mounted antennas each produce and emit the electromagnetic interrogation field at a specific frequency when excited by suitable electronic circuitry. The interrogation fields together form an interrogation zone in which the RFID device can be interrogated and detected. If an RFID transponder is positioned within the interrogation zone for a sufficient time and is able to receive appropriate commands from the reader as well as adequate RF power to operate the device, it will become stimulated and transmit, either by generation of a radio frequency signal or by reflective means, commonly described as modulated backscatter, a uniquely coded signal that is received by the antennas or a separate receiving antenna. The response signal can be read by the reader, typically with a readable range on the order of a few feet, though broader or narrower ranges are possible.

An RFID tag is a transponder that can be either an active transponder or a passive transponder or a passive transponder. An active transponder has its own internal battery, whereas a passive transponder does not have its own internal battery and generates its required power through electromagnetic coupling to an interrogation field. Passive transponders are generally less expensive than active transponders. One traditional drawback of RFID systems which include passive transponders has been their relatively limited read range.

The terms “RFID reader”, “RFID scanner”, “reader” and “scanner” are used herein interchangeably.

A common application of RFID systems is in tracking packages and other articles traveling on conveyors, for example in a distribution center. In order to identify and properly route individual packages traveling through a distribution center, it is necessary to provide and detect an identification code associated with each package. Traditionally, this has been done with printed bar codes, using bar code readers that may be placed over conveyor belts. When using such bar codes systems it is necessary to orient the packages with the bar codes facing upwardly and otherwise to orient and place the packages on the conveyor belt so that the bar codes will be detected and not be damaged by forklifts.

Several problems in implementing RFID technology have been encountered. In a warehouse or distribution center, some tags fail to be read by scanners due to shielding of radio signals resulting from radio frequency (RF) blocking materials (like metal or liquids), interference between multiple tags nodes in the distribution of emitted radio signals, distance between tags and scanners, and other factors. For example, in a pallet with multiple stacked cases of products, products in the center may not be read easily, while those on the outer portions of the pallet may be readily detected by scanners.

In the case of detection of RFID tagged packages on a conveyor, improvements in reading distance of passive RFID tags may however create another problem. The conveyor reader may simultaneously detect multiple tagged packages at one time, especially if such packages are located relatively close together on the conveyor. It is not desirable to turn the conveyor reader power down to reduce the reading range, as the position of a package and its contents can greatly attenuate the signal, making the reading unreliable at reduced power. Thus there is a need to discriminate between multiple detected packages according to their location on the conveyor.

One of the ways to try and overcome part of the above setbacks is by incorporating cascading smart tags, wherein groups of products such as cases, pallets, or truckloads are associated with a “macro tag” that provides information about smaller groupings of products or individual products and their associated tags.

To overcome some of the above problems, U.S. Pat. No. 7,088,248 assigned to Forster introduced different RFID detection systems that include jamming signal transmitters to inhibit detection of RFID devices outside of a specified area. Or includes an RFID device reader and jamming signal transmitters operatively coupled to the reader, to aid the reader in avoiding detection of RFID devices outside of a predetermined specified area. Or includes a pair of spaced-apart loops for emitting low-frequency electromagnetic fields, wherein the fields are substantially opposite in phase.

FIG. 2 (prior art) depicts an RFID tag 20 attached to a central supporting cube 80 of a wooden pallet 90. One of the problems detected in prior art RFID systems was the fact that the RFID tags had to be attached to or otherwise placed on the surface of pallet 90 in order to be readable by a scanner 30. Externally attached RFID tags 20 are exposed to damage by lift truck (e.g., a forklift) and are readable in certain angles only. Reference is now made to FIG. 3 (prior art) which illustrate the influence of angle θ between the surface of an RFID tag 20 and the transmission axis of the RF signal transmitted by antenna 32 of an RFID reader 30. AN RFID tag 20 has an effective field of view φ within which envelop the antenna of an RFID tag 20 has a good reception of RF signal 35 sent by an RFID reader 30. If θ>φ/2, the reliability of the reception of the activation signal 35 by tag 20 decreases. When θ=90° (θc in FIG. 3), reception is minimal and the reliability of the reception of the activation signal 35 by tag 20 is typically reduced to 50%. Hence, referring back to FIG. 2, when a forklift approaches a pallet 90 having an RFID tag 20 attached to a central supporting cube 80 of pallet 90, in on orientation θ=90°, but in the other orientation θ=0°, which is unacceptable.

Yet another of the problems detected in previous systems was the fact the RFID devices could not be implanted or attached to wooden pallets for dampness reasons (since the wetness or humidity shield radio signals) and therefore plastic pallets were considered. The present invention solves the problem and gives a new solution for using wooden pallets thus avoiding the dampness setbacks.

Yet another of the problems detected in previous systems was the fact the RFID devices could is typically attached to pallets by metal nails which shield radio signals. US patent application 20070108296 by John Konopka et al., provides an RFID device with an RFID tag is positioned at a particular location inside of a chamber of a device or object to be identified, such as a metallic chamber of a pallet, and spaced away from metallic structures by a gap. This solution requires an RFID device in each of the pallet directions.

US patent application 20060255950 by William Roeder et al., provides a solution that requires a complex reading mechanism including at least one ruggedized antenna mounted on the tine (or other base-level platform) of a lift truck (e.g., a forklift). The antenna can be configured to read RFID tags on pallets that are loaded on the lift truck and communicate the tag information to a warehouse management system.

Yet another problem was detected in previous systems were the systems use “semi active” RFID UHF tags requiring power source attached to or embedded in plastic pallets. The power source needs to be replaced quite frequently, therefore requires constant maintenance being costly thus not practical.

The present invention introduces an improved system that overcomes most of the known problems and ensures that products are detected even when there is RF shielding or other problems that causes some tags in a group of products not to be read.

The present invention introduces a special passive smart tag requiring no power source, embedded into a pallet for the life of the pallet with no need of any special maintenance. The smart tag is integrated in a special support cube, sealed to protect the tag from any fluid penetration. The smart tag is implanted substantially vertically into the cube, forming an angle of 45° relative to each of the cube vertical sides, such that the smart tag can be read in a high level reliability and long at ranges by a lift truck (e.g., a forklift) approaching the pallet from any of the 4 possible directions.

The terms “RFID reader”, “RFID scanner”, “reader” and “scanner” are used herein interchangeably.

### SUMMARY OF THE INVENTION

The present invention introduces a passive smart tag requiring no power source, typically using UHF or HF signals, embedded into a pallet for the life of the pallet with no need of any special maintenance. The smart tag is integrated in a special support cube, sealed to protect the tag from any fluid penetration. The smart tag is implanted substantially vertically into the support cube, forming an angle of 45° relative to each of the cube vertical sides, such that the smart tag can be read in a high level reliability and long at ranges by a forklift approaching the pallet from any of the 4 possible directions. The special supporting cube is typically placed at a central location of the pallet. The shape of the special support cube is typically of a cube or a rectangular parallelepiped, but is not limited by these shapes and can be formed in any other shape. The special support cube is typically made of material that is not shielding RF signals, such as plastic, wood, polyurethane, etc.

Accordingly, it is the intention of the present invention is to provide a novel device for positioning and RFID smart tag in pallets that is free of the shortcomings and drawbacks of prior art RFID systems and methodologies.

An aspect of the present invention is to provide an RFID smart tag system that utilizes low cost materials to provide visible indicia while using special passive smart tag requiring no power source embedded into a pallet for the life of the pallet with no need of any special maintenance.

An aspect of the present invention is to provide an RFID smart tag system that provides visible indicia from 4 angles, due to its location in the center of a special cube which is integrated into a pallet, at a central location.

Another aspect of the present invention is to provide an RFID smart tag system where the smart tag is integrated in a special cube which is sealed to protect the smart tag and fluids or humidity.

The pallet can be made of any common material used for pallets, including wood, plastic, etc.

### BRIEF DESCRIPTION OF THE DRAWINGS

The present invention will become fully understood from the detailed description given herein below and the accompanying drawings, which are given by way of illustration and example only and thus not limitative of the present invention, and wherein:

FIG. 1 (prior art) shows a conventional RFID system consisting a reader and a tag;

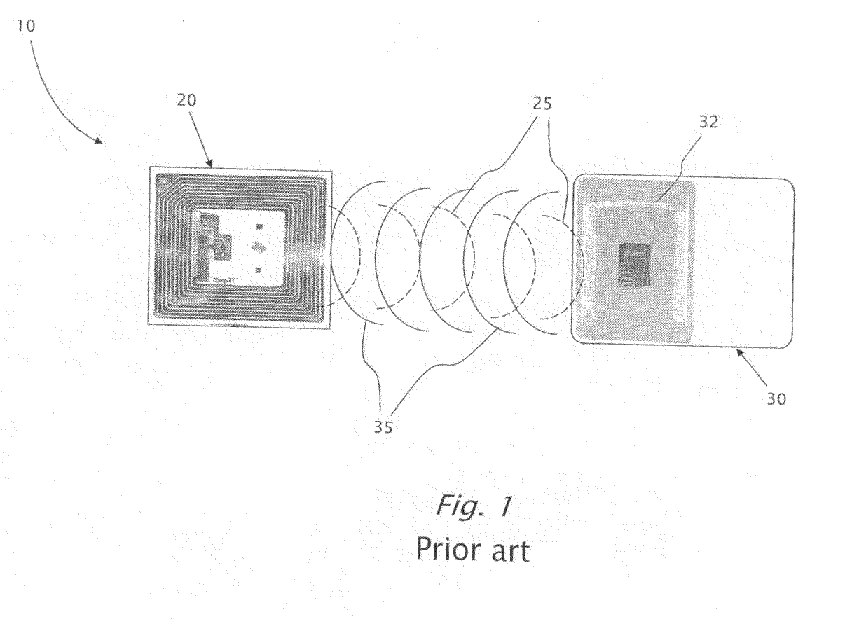

FIG. 2 (prior art) depicts an RFID tag attached to the central supporting cube of a wooden pallet;

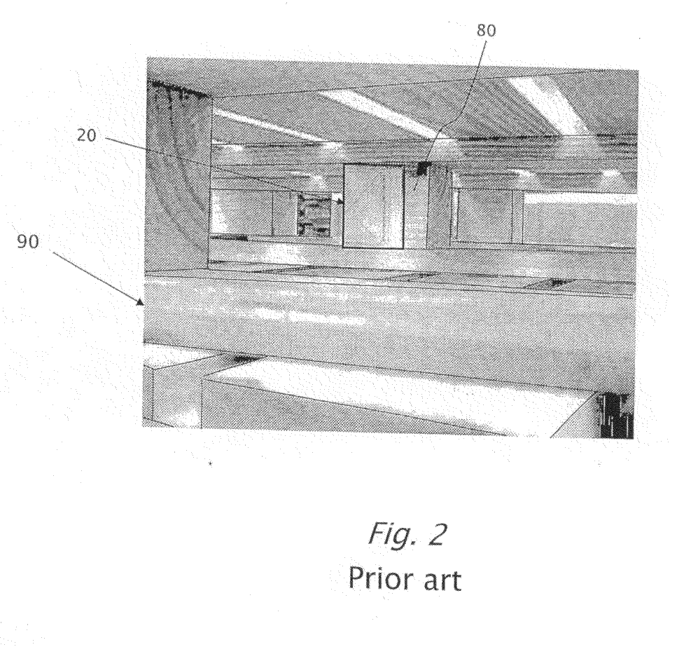

FIG. 3 (prior art) illustrates the influence of the angle between the surface of an RFID tag and the transmission axis of the RF signal transmitted by an RFID reader;

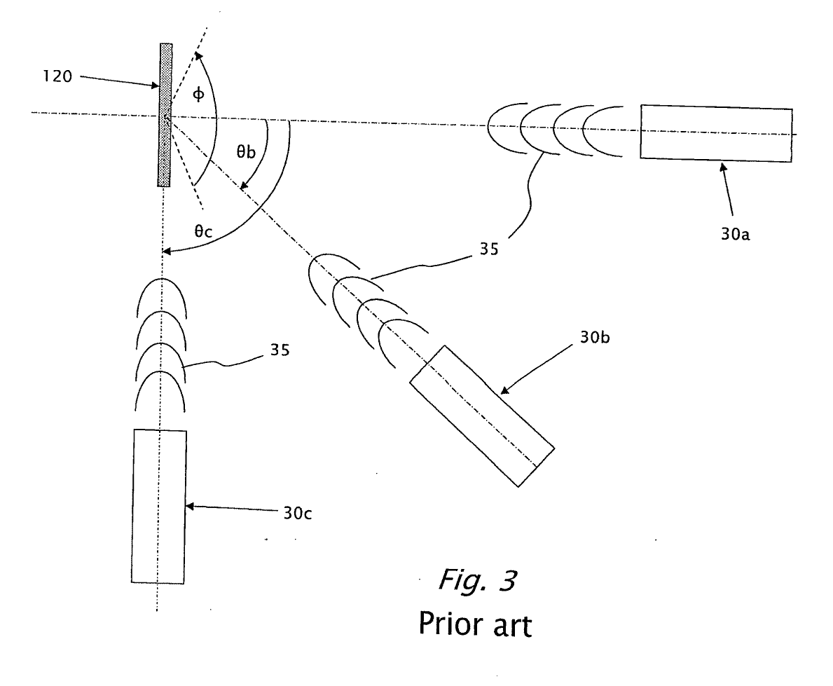

FIG. 4 shows a schematic perspective view of an RFID device containing and RFID tag for a pallet, according to embodiments of the present invention;

FIG. 5 illustrates a bottom view of a pallet with an RFID device containing and RFID tag, according to embodiments of the present invention;

FIG. 6 illustrates the indifference of the approach direction of a forklift reading the RFID tag embedded inside the RFID device, which is integrated into the pallet, according to embodiments of the present invention; and

FIG. 7 illustrates the steps of method for producing a pallet including an RFID device containing an RFID tag, according to embodiments of the present invention.

### DESCRIPTION OF THE PREFERRED EMBODIMENTS

Before explaining embodiments of the invention in detail, it is to be understood that the invention is not limited in its application to the details of construction and the arrangement of the components set forth in the host description or illustrated in the drawings.

Unless otherwise defined, all technical and scientific terms used herein have the same meaning as commonly understood by one of ordinary skill in the art of the invention belongs. The methods and examples provided herein are illustrative only and not intended to be limiting.

It is the present invention is to provide an RFID smart tag system that utilizes low cost materials to provide visible indicia while using special passive smart tag requiring no power source embedded into a pallet for the life of the pallet with no need of any special maintenance, such that the smart tag can be read in a high level reliability and from relatively long ranges by a forklift approaching the pallet from any of the 4 possible directions. RFID smart tag system typically uses a passive smart tag requiring no power source, and typically using UHF or HF signals, but the present invention is not limited to RFID systems that use a passive smart tag and/or using UHF or HF signals.

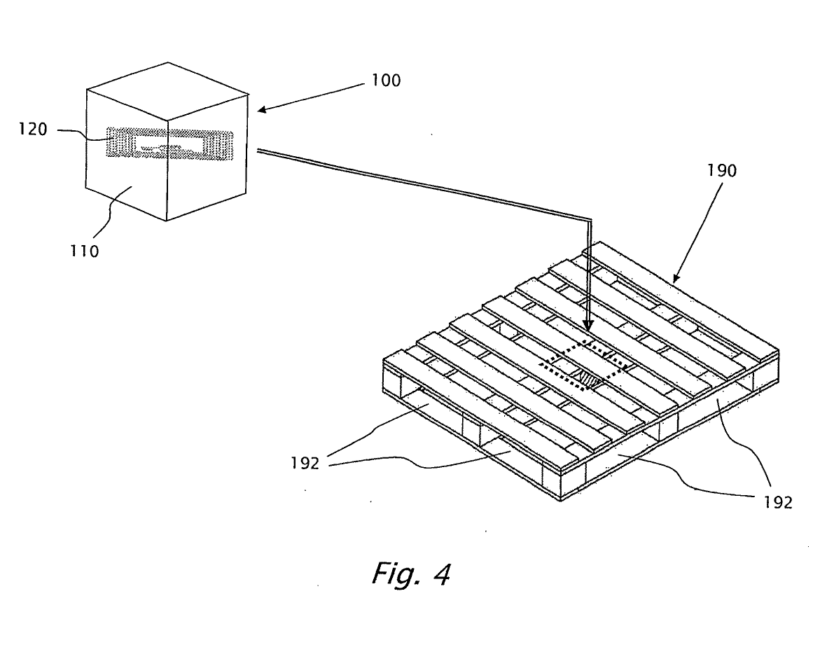

Reference is now made to FIG. 4, which shows a schematic perspective view of an RFID device 100 for a pallet 190, according to embodiments of the present invention. RFID device 100 includes a passive smart tag 120 that is embedded into supporting cube 110. RFID device 100 is sealed to protect smart tag 120 from fluid or humidity penetration, and is integrated into pallet 190. It should be noted that pallet 190 can be made of any common material used for pallets, including wood, plastic, etc.

RFID device 100 is typically placed at a central location of pallet 190. The shape of cube 110 is typically of a cube or a rectangular parallelepiped, but is not limited by these shapes and can be formed in any shape. Cube 110 is typically made of materials that are not shielding RF signals, such as plastic, recycled plastic, wood, particle board, MDF, polyurethane, or any other material the like.

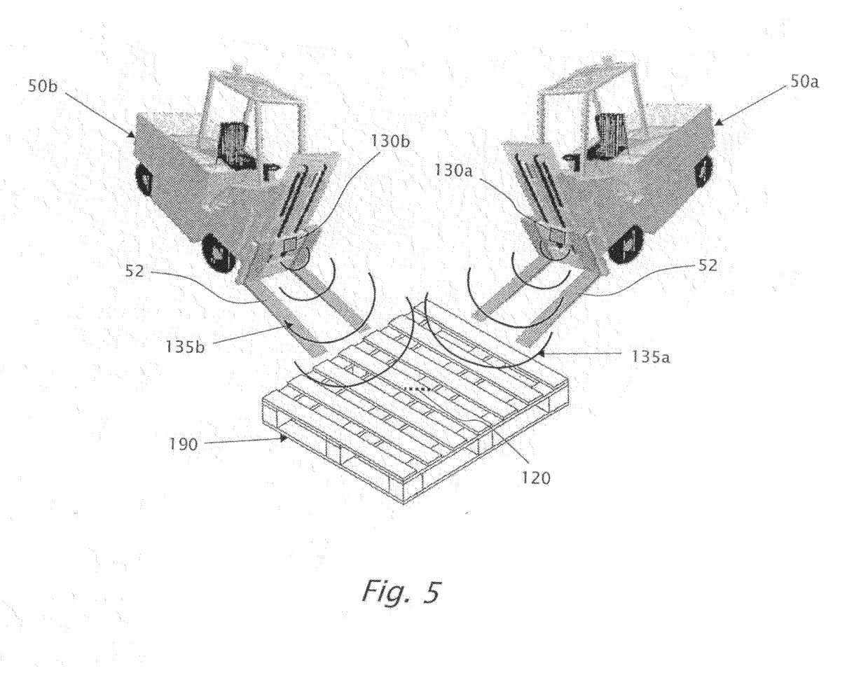

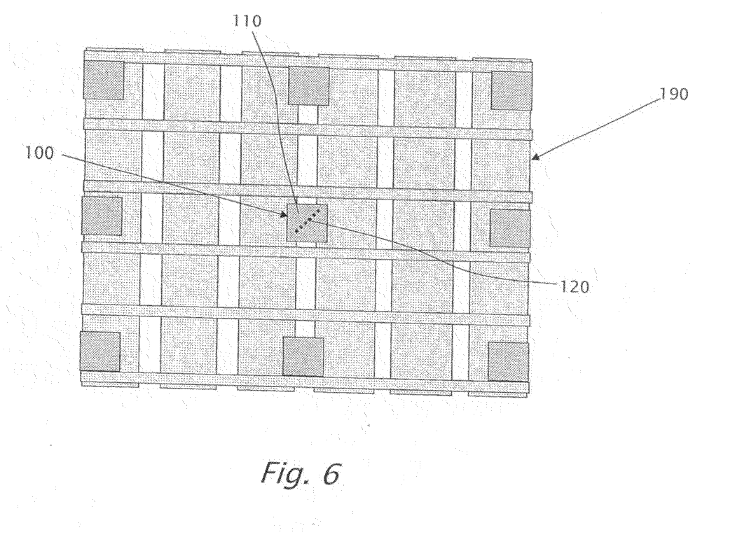

Reference is made to FIG. 5, which illustrates a bottom view of a pallet 190 with an RFID device 100 containing and RFID tag 120, according to embodiments of the present invention. Pallet 190 is shown with the bottom surface layer removed. Smart tag 120 is implanted substantially vertically into RFID device 100, forming a 45° (±5°) angle with each of supporting cube 110 vertical sides, such that tag 120 can be read in a high level reliability and from relatively long ranges by a forklift approaching pallet 190 from any of the 4 possible directions. The angle of 45° is optimal for all directions. Reference is also made to FIG. 6, which illustrates the indifference of the approach direction of a forklift 50 reading RFID tag 120 embedded inside RFID device 100, which is integrated into pallet 190, according to embodiments of the present invention. Readers 130a and 130b transmitting RF signals 135a and 135b respectively, activate tag 120 with substantially the same level of reliability. FIG. 6 illustrates forklifts 50 approaching pallet 190 from two orthogonal directions whereas the other two possible directions are 180° to the illustrated directions.

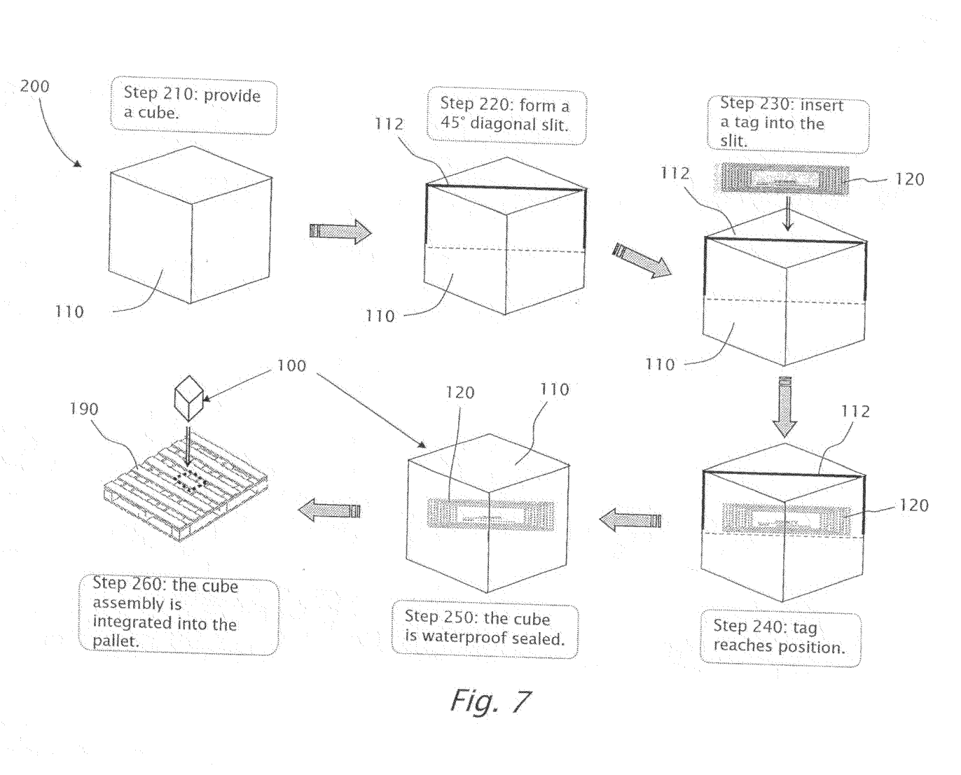

Reference is now made to FIG. 7, which illustrates the steps of a method 200 for producing an RFID device 100 containing an RFID tag 120, according to embodiments of the present invention, designated for a wooden pallet 190, but can also be used for other types of pallets. To manufacture RFID device 100 a cube 110 is provided in step 210. Process 200 proceeds with the following steps:
Step 220—form a 45° diagonal slit 112.
   A slit 112 is formed diagonally from the top of cube 110 inwardly. The depth of slit 112 is such that tag 120 can completely placed inside and safely sealed inside slit 112.
Step 230—insert a tag 120 into the slit 112.
   Smart tag 120 is inserted into slit 112.
   In embodiments of the present invention, two or more tags 120 are inserted to slit 112, to enable multiple types of RFID readers to identify RFID device 100, and thereby identify pallet 190 into which RFID device 100 is integrated. For example, one tag 120 is a UHF tag 120 and a second tag 120 is an HF tag 120. When two or more tags 120 are inserted to slit 112, the tags are isolated, for example by a partition made of materials, such as materials from which cube 110 is made of to prevent one tag 120 from operatively disturbing a neighboring tag 120.
Step 240—tag 120 reaches its position inside slit 112.
   Smart tag 120 is positioned inside slit 112 such that tag 120 can be sealed inside slit 112.
Step 250—cube 110 is waterproof sealed.
   Cube 110 is waterproof sealed such that tag 120 is completely protected from fluids and humidity. The waterproof sealing prevents and physical damage of tag 120, as well as prevents shielding of RF signal transmitted towards tag 120 a reader 30.
Step 260—RFID device 100 is integrated into the pallet 190.
   To operate RFID device 100, RFID device 100 is integrated into the pallet 190 at a central location of pallet 190. RFID device 100 is placed inside pallet 190 such that it is protected from external activity on the two surfaces of pallet 190 taking place in pallet 190 life time. RFID device 100 is protected from external damages of forklifts 50 and thus does not affect the life span of pallet 190, which is similar to that of a regular pallet 90.
   The sides of RFID device 100 are generally parallel to the sides of pallet 190, and to the pathways 192 (see FIG. 4) for tines 52 of a forklift 50.

In embodiments of the present invention, cube 110 is manufactured including slit 112, such as in plastic molding or casting or any other production process using a given material. In cases, where cube 110 is manufactured such that cube 110 includes slit 112, step 220 of method 200 is skipped.

In embodiments of the present invention, cube 110 is manufactured including more than one slit 112, to enable inserting one or more tags 120 to each slit 112. For example, one slit 112 may contain a UHF tag 120 and a second slit 112 may contain an HF tag 120.

The invention being thus described in terms of embodiments and examples, it will be obvious that the same may be varied in many ways. Such variations are not to be regarded as a departure from the spirit and scope of the invention, and all such modifications as would be obvious to one skilled in the art are intended to be included within the scope of the claims.

1-22. (canceled)

23. An RFID tag system for a pallet, the system comprising:
the pallet;
an RFID housing in the pallet;
at least one RFID tag in the housing;
each side of the pallet being oriented substantially in a vertical plane;
each of the at least one RFID tags being oriented substantially in a direction that forms an angle between about 35° and about 55° with each of the vertical planes;
wherein data stored on each of the at least one RFID tags can be read with high reliability by an RFID reader from any of the sides of the pallet.

24. The system of claim 23, wherein said pallet is a wooden pallet.

25. The system of claim 23, wherein at least one of the at least one RFID tags is a passive RFID tag.

26. The system of claim 23, wherein
the at least one RFID tag comprises a first RFID tag and a second RFID tag;
the first RFID tag operates optimally in a first bandwidth;
the second RFID tag operates optimally in a second bandwidth;
the first bandwidth is not identical with the second bandwidth.

27. The system of claim 26, wherein
the first bandwidth is UHF;
the second bandwidth is HF.

28. The system of claim 23, wherein the at least one RFID tag is sealed in the RFID housing to protect the at least one RFID tag from fluids and humidity.

29. The system of claim 23, wherein the RFID housing is composed of materials that do not inhibit transmission of radio frequency signals to and from the at least one RFID tag.

30. The system of claim 23, wherein the RFID housing comprises a structurally supporting element of the pallet.

31. The system of claim 23, wherein the RFID housing is substantially in the shape of a rectangular parallelepiped.

32. The system of claim 23, wherein at least one of the at least one RFID tags is oriented substantially in a direction that forms an angle of about 45° with each of the vertical planes.

33. A method of manufacturing an RFID tag system for a pallet, the method comprising:
constructing the pallet, with each side of the pallet being oriented substantially in a vertical plane;
including an RFID housing in the pallet, wherein the RFID housing comprises at least one RFID tag that is sealed in the RFID housing to protect the RFID tag from fluids and humidity, and wherein the RFID housing is composed of materials that do not inhibit transmission of radio frequency signals to and from the at least one RFID tag;
orienting the RFID housing in the pallet so that each of the at least one RFID tags is oriented substantially in a direction that forms an angle between about 35° and about 55° with each of the vertical planes;
wherein data stored on each of the at least one RFID tags can be read with high reliability by an RFID reader from any of the sides of the pallet.

34. The method of claim 33, further comprising using the RFID housing as a structurally supporting element of the pallet.

35. The method of claim 33, further comprising:
including pathways in the pallet in which forks of a forklift may be inserted;
orienting at least two sides of the RFID housing substantially parallel to the pathways.

36. The method of claim 33, wherein the orienting step further comprises orienting the RFID housing in the pallet so that at least one of the at least one RFID tags is oriented substantially in a direction that forms an angle of about 45° with each of the vertical planes.

37. The method of claim 33, wherein the constructing step further comprises constructing the pallet primarily of wood.

38. The method of claim 33, wherein the RFID housing is substantially in the shape of a rectangular parallelepiped.

39. The method of claim 33, wherein at least one of the at least one RFID tags is a passive RFID tag.

40. The method of claim 33, wherein
the at least one RFID tag comprises a first RFID tag and a second RFID tag;
the first RFID tag operates optimally in a first bandwidth;
the second RFID tag operates optimally in a second bandwidth;
the first bandwidth is not identical with the second bandwidth.

41. The method of claim 40, wherein
the first bandwidth is UHF;
the second bandwidth is HF.
